(19) United States
(12) Patent Application Publication
(10) Pub. No.: US 2008/0313019 A1
(43) Pub. Date: Dec. 18, 2008

(54) SYSTEM AND METHOD FOR EXTRACTING CONTACT INFORMATION FROM WEBSITE TRAFFIC STATISTICS

(76) Inventor: Martin C. Jeffers, Littleton, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/139,360

(22) Filed: Jun. 13, 2008

Related U.S. Application Data
(60) Provisional application No. 60/934,485, filed on Jun. 14, 2007.

(51) Int. Cl. G06Q 10/00; G06F 17/30

(52) U.S. Cl. 705/10

(57) ABSTRACT

A system and method for providing user-defined business contact information, relating to website traffic statistics, to a user approximately in real-time is described. One embodiment comprises receiving visitor information associated with a visitor to a website, wherein the visitor information includes at least an IP address of the visitor and a query string; determining an entity associated with the IP address; determining at least one person associated with the entity; gathering contact information associated with the at least one person; and providing the contact information to the user when the contact information meets a pre-defined criterion of the user.

### PRIORITY

The present application claims priority to commonly owned and assigned provisional application No. 60/934,485, filed Jun. 14, 2007, entitled METHOD AND SYSTEM FOR SEARCHING AND APPENDING BUSINESS CONTACTS INFORMATION TO WEBSITE VISITOR DATA, which is herein incorporated by reference in its entirety.

### FIELD OF THE INVENTION

The present invention relates generally to Internet technology. More particularly, but without limitation, the invention relates to systems and methods for extracting contact information from website traffic statistics relating to the business associated with a visitor to a website and providing user-defined business contact information relating to the website traffic statistics to a user approximately in real-time.

### BACKGROUND OF THE INVENTION

As the World Wide Web became increasingly popular in the mid-1990's, website owners wanted to know information about the traffic coming to their websites. Thus, website traffic reporting applications evolved to provide such information. Traditionally, web servers capture visitor information and store it serially in log files. Log files typically capture each website visit on a page-by-page basis. For each page viewed by a visitor, a single record is generated and stored in a log file. Each record generally captures the actual web page visited, how the visitor reached the web page (i.e., referrer information), and the Internet Protocol (“IP”) address of the visitor. With this information, additional statistics and analysis are extracted and reported to the website owner on a daily basis. Such statistics often include the length of a website visit and how many pages the visitor viewed, among other things.

A feature desired by website owners is knowledge of who is visiting their websites. Under current technology, knowledge of the individual person visiting a website is indeterminable. However, the IP address attached to each record in a log file provides some insight into who visits a website. An IP address is a unique address, much like a physical address, that is assigned to individual hardware devices such as a personal computer (“PC”), or mobile device used for browsing the Internet, or to a location with many computers. For example, each connection, used by a PC, to connect to the Internet has a unique IP address. This address is a 12-digit number that identifies, to some degree, where the PC is located and with which Internet service provider (“ISP”) or business the PC connection's IP address is associated. This information is also known as registrant information. In other words, the IP address of a given PC's connection used for accessing a website may specify the company with which a website visitor is associated.

However, there are limitations to such information. For example, if the IP address for a given PC's connection shows AT&T as the internet service provider, this may be of little use to a website owner. With millions of people using AT&T for Internet service, little value may exist in this information. However, website visitors originating from an identifiable business may provide valuable information to the website owner.

Additionally, owners of commercial websites may like to know more than the businesses that visit a website. Additional knowledge about the business, or persons within the business having interest in the websites' products or services may provide value. The term “business,” as used throughout this application, should not be limited to for-profit businesses. For-profit and non-profit organizations, government facilities, and other entities may be included with the definition of “business.”

An additional shortcoming to traditional web traffic reporting applications is the delay in processing and receipt of such reporting information. Many reporting applications process weblog files on a nightly basis, with the reports becoming available to users the following day. Up to 24-hour delays are typical. It is desirable to receive such information on a quicker basis. Hence, a system and method is needed to capture, extract, and report additional website visitor statistics approximately in real-time, beyond what is currently available to website owners using current web traffic reporting applications.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a method and system for providing contact information relating to website traffic statistics to a user. One illustrative embodiment is a method comprising receiving visitor information associated with a visitor to a website, wherein the visitor information includes an IP address of the visitor; determining an entity associated with the IP address; determining at least one person associated with the entity; gathering contact information associated with the at least one person; and providing the contact information to the user when the contact information meets a pre-defined criterion of the user.

Another illustrative embodiment is a system for providing contact information relating to website traffic statistics to a user comprising at least one processor and a memory containing a plurality of program instructions configured to cause the at least one processor to receive visitor information associated with a visitor to a website, wherein the visitor information includes an IP address of the visitor; determine an entity associated with the IP address; determine at least one person associated with the entity; gather contact information associated with the at least one person; and provide the contact information to the user when the contact information meets a pre-defined criterion of the user.

Another illustrative embodiment is a system for providing contact information relating to website traffic statistics to a user, the system comprising a website traffic analysis engine; a data warehouse for storing website visitor information, the data warehouse being coupled to the analysis engine; a website visitor module for receiving visitor information from a website, the website visitor module being coupled to the analysis engine; an entity resolution module for determining an entity associated with a visitor to a website, the entity resolution module being coupled to the analysis engine; a contact resolution module for determining contact information of at least one person associated with the entity, the contact resolution module being coupled to the analysis engine; a contact preferences module for collecting user-defined preferences of desired contact types, the contact preferences module being coupled to the analysis engine; a communication module for communicating visitor and contact information to the user, the communication module being coupled to the analysis engine and the data warehouse; a report generation module for generating reports comprising information from the data warehouse, the report generation module being coupled to the analysis engine, the data warehouse, and the communication module; and a client interface for presenting reports generated by the report generation module, the client interface being coupled to the analysis engine and the data warehouse.

The present invention can provide a system and method for extracting, approximately in real-time, contact information about the business visiting a website from website traffic statistics.

The invention may also be embodied at least in part as program instructions stored on a computer-readable storage medium, the program instructions causing a processor to carry out the methods of the invention.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a functional block diagram of a computer equipped with a web traffic analysis application in accordance with an illustrative embodiment of the invention;

FIG. 2 is a functional block diagram of a system for analyzing web traffic and generating information relating to the web traffic in accordance with an illustrative embodiment of the invention;

FIG. 3 is table illustrating information acquired for each visitor navigating to a website in accordance with an illustrative embodiment of the invention;

FIG. 4 is a flowchart illustrating a method for providing, to a user, business contact information relating to a website visit in accordance with an illustrative embodiment of the invention;

FIG. 5 is a flowchart illustrating another method for providing business contact information to a user in accordance with an illustrative embodiment of the invention; and

FIG. 6 is a flowchart illustrating a method for requesting and receiving a visitor and contacts report in accordance with an illustrative embodiment of the invention.

### DETAILED DESCRIPTION

In various illustrative embodiments of the invention, the problem of gathering useful contact information from the visitors to a website is addressed by utilizing one or more databases comprising personnel information from the business associated with a website visitor. In some embodiments, the extraction and presentation of contact information is accomplished approximately in real-time, thus, further increasing the value of visitor contact information. The terminology “approximately in real-time” may be measured in milliseconds to a few minutes depending on network congestions, computer processing capabilities, etc. In other words, capturing data approximately in real-time is not accomplished in the traditional method of batch processing over longer intervals of time. But rather, it is accomplished as soon as a website visit occurs and the information becomes available. Data capture methods are utilized by embedding scripts into individual web pages within a website to extract visitor contact information approximately in real-time. The extracted visitor contact information is then stored in the referenced application and database and cross-referenced with one or more data repositories to determine the underlying business associated with the website visitor. Information such as business name, address, city, state, country and geolocation may be provided. In one embodiment, the term “geolocation” refers to the general physical location of a hardware device as indicated in the IP address assigned to that hardware device. In other words, some of the digits in the IP address of a PC browsing the Internet contain information regarding the physical location of that PC. Usually the location is limited to city, state, and country. However, more or less information may be found in some circumstances.

Additional embodiments of the invention permit retrieval of contact information for some of the personnel associated with the business. Once the business associated with the website visitor is determined, additional data repositories may be queried to find individual persons associated with that business. Such information may include name, address, phone, position, and title, to name a few.

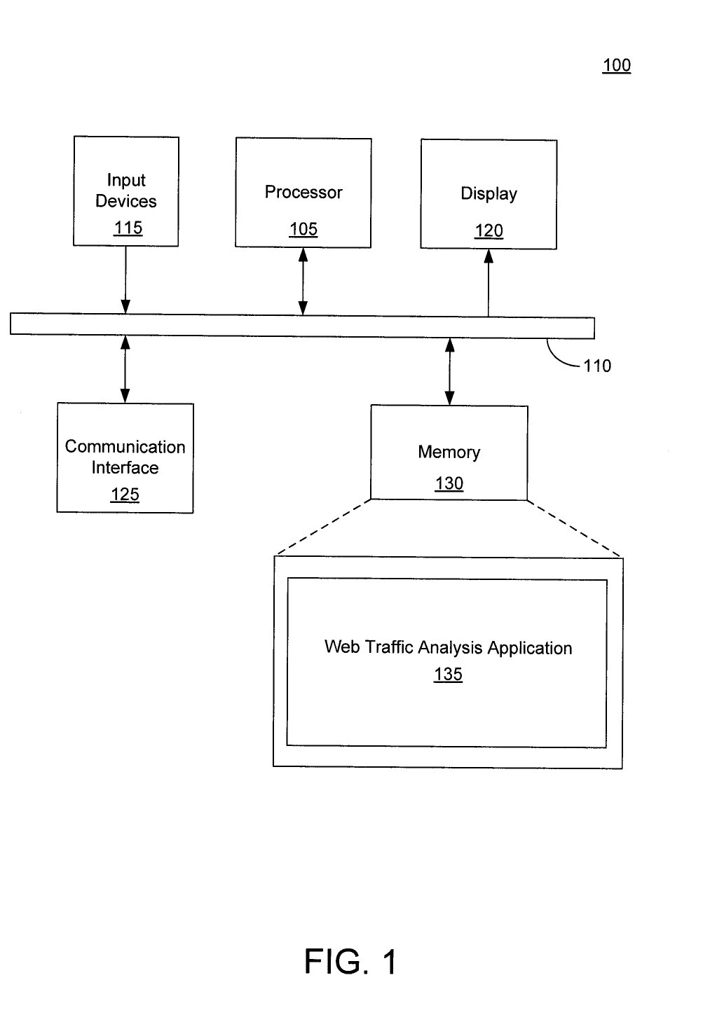

Referring now to the drawings, where like or similar elements are designated with identical reference numerals throughout the several views, and referring in particular to FIG. 1, it is a functional block diagram of a computer 100 equipped with a web traffic analysis application 135 in accordance with an illustrative embodiment of the invention. Computer 100 may be any computing device capable of running a web traffic analysis application 135. For example, computer 100 may be, without limitation, a personal computer (“PC”), a server, a workstation, a laptop computer, or a notebook computer.

In FIG. 1, processor 105 communicates over data bus 110 with input devices 115, display 120, communication interface 125, and memory 130. Though FIG. 1 shows only a single processor, multiple processors or multi-core processors may also be used.

Input devices 115 may include, for example, a keyboard, a mouse or other pointing device, or other devices that are used to input data or commands to computer 100 to control its operation.

In the illustrative embodiment shown in FIG. 1, communication interface 125 is a Network Interface Card (“NIC”) that implements a standard such as IEEE 802.3 (often referred to as “Ethernet”) or IEEE 802.11 (a set of wireless standards). In general, communication interface 125 permits computer 100 to communicate with other computers via one or more networks.

Memory 130 may include, without limitation, random access memory (“RAM”), read-only memory (“ROM”), flash memory, magnetic storage (e.g., a hard disk drive), optical storage, or a combination of these, depending on the particular embodiment. In FIG. 1, memory 130 includes web traffic analysis application 135. Herein, the web traffic analysis application 135 refers to a computer application or automated script. The application receives website traffic files approximately in real-time, analyzes their contents, cross-references the files to one or more additional databases, and produces information relating to individual contact persons associated with businesses contained in the weblog. Such information may be used by sales and marketing personnel associated with the visited website to contact these individuals for sales purposes. Further, this information may also be useful in adjusting the website's content to improve the Visitor's experience and enhance the website's marketing activities through search engines, etc.

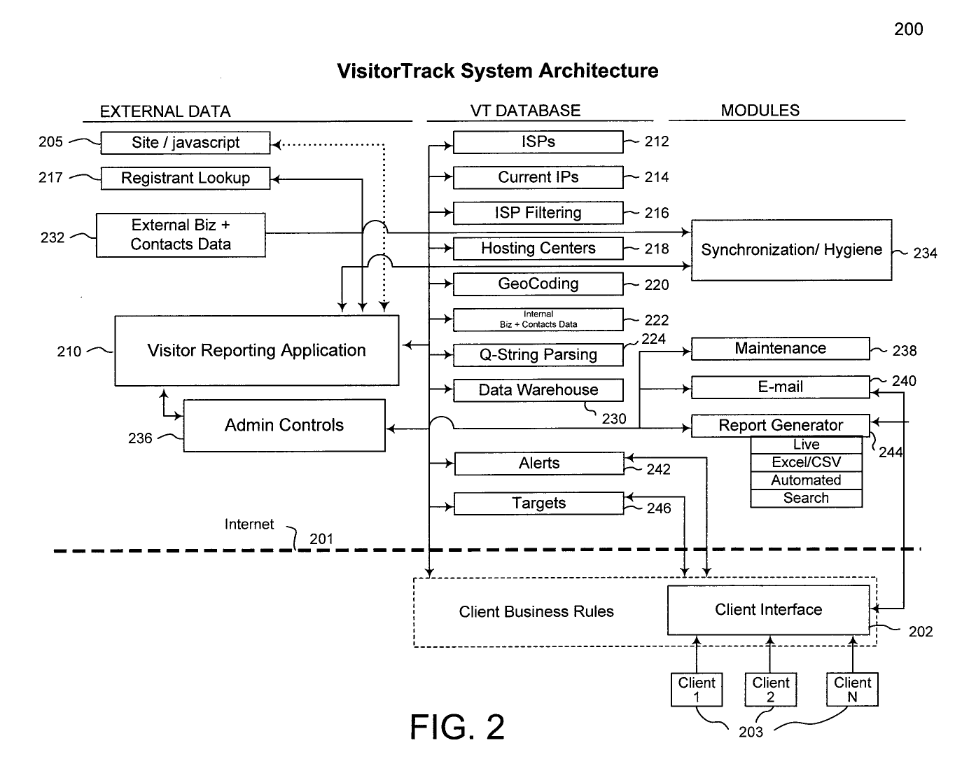

In the illustrative embodiment of FIG. 1, web traffic analysis application 135 may include additional modules to provide the functionality described above. FIG. 2 is one embodiment of the individual modules, components and databases that may comprise the web traffic analysis application 135.

In one illustrative embodiment, web traffic analysis application 135 and its functional modules (not shown in FIG. 1) are implemented as software that is executed by processor 105. Such software may be stored, prior to its being loaded into RAM for execution by processor 105, on any suitable computer-readable storage medium such as a hard disk drive, an optical disk, or a flash memory. In general, the functionality of web traffic analysis application 135 may be implemented as software, firmware, hardware, or any combination or sub-combination thereof.

FIG. 2 is a functional block diagram of a system for analyzing web traffic statistics and generating information relating to the web traffic in accordance with an illustrative embodiment of the invention. In one embodiment, the system 200 as illustrated in FIG. 2 may be a server side configuration of modules, databases, and application interfaces. The server side system 200 may also be referred to, in some embodiments, as the VisitorTrack System (“VT System”) 200. Users may utilize client devices 203 to access the information provided by the VT System 200 via the client interface 202. The client devices 203 may access the client interface 202 through the Internet 201, a local area network (“LAN”), a wide area network (“WAN”), wirelessly or by other connections mechanisms known in the art. In another embodiment, the client devices may be a PC, a mobile device, or other devices known in the art. In yet another embodiment, client devices send reports containing website visitor and relevant contact data in common file formats such as comma-separated values (“CSV”), Portable Document Format (“PDF”), spreadsheets, e-mail, and instant messaging.

A website owner or the personnel responsible for maintaining a website (hereinafter “owner”) may implement the VT System's 200 reporting capabilities by embedding scripts to the pages of their website 205. Such scripts may be activated when a visitor navigates to a web page equipped with a script. In one embodiment, JAVASCRIPT may be used as the language for writing the scripts. However, one skilled in the art will appreciate that any scripting language may be used including but not limited to CGI, PYTHON, PERL, HTML, XML, and others.

When a visitor navigates to a script-equipped web page of the website 205, the script reads information from the visitor's web browser. In one embodiment, the information captured from a web browser may include, the IP address of the device used to navigate to the website, the Uniform Resource Locator (“URL”) of the pages visited by the visitor, the referral information (i.e., the previous page or website the visitor visited or the search words used if the visitor came from a search engine), and optional information left on the visitor's computer used to show repeat visits to the website 205, such as from the use of tracking cookies. One skilled in the art may appreciate that additional or reduced information may be captured from the web browser without deviating from the scope of the invention. Once the script receives the above information, the information may be transmitted to the Visitor Reporting Application (“VRA”) 210.

In one embodiment, the information transmitted by the script may be sent approximately in real-time. Once the information is received by the VRA 210, processing and analysis of the information (described later) may also begin approximately in real-time. This approach differs from traditional web traffic reporting applications which typically process weblogs in 24 hour intervals. Hence, an owner wanting to know the activity from his or her website may often wait until the following day for this information. In contrast, the VT System 200 may communicate the extracted web browser data as soon as the visitor arrives to the web page and the browser information is obtained, providing the owner with valuable statistics in a short interval (e.g., within seconds or minutes in some embodiments) after the visitor navigates the website 205.

In one embodiment, the VRA 210 is a server-side application which receives web traffic information, normalizes the information, cross-references this information with one or more additional databases, and provides the information to a user in one of many mediums. In one embodiment, VRA 210 interacts with multiple functional modules and databases that are responsible for normalizing the received web traffic information, cross-referencing the information with other databases, and storing the information in one or more databases or data warehouses for further access.

According to the system illustrated in FIG. 2, there are many databases providing differing information and functionality. In one embodiment, one or more of these databases may further include a functional module for accessing and transmitting information to and from the respective databases. In another embodiment, one or more of the databases may be a relational or object-oriented database. These databases include, but are not limited to, the ISP Database 212, the Current IP Database 214, the ISP Filtering Database 216, the Hosting Centers Database 218, the Geo Coding Database 220, the Internal Business and Contacts Database 222, The Query String Parsing Database 224, and the Storage Data Warehouse 230. The layout of information for each database described above is merely one example for implementing this information. Additional or a reduced number of databases may be utilized without deviating from the scope of the invention. Further, the term “database” should not be limited to a relational database. Comma-delimited files, flat files, spreadsheets, object-oriented databases, and others may be used under the general term “database.”

The ISP Database 212 stores IP addresses previously known to be owned by or associated with an ISP. IP addresses associated with an ISP are often discarded. The reason for discarding IP addresses owned by an ISP is the difficulty is determining the true visitor's association. If a small business uses AT&T as their ISP, the IP address may show as being owned or controlled by AT&T and not the name of the underlying business.

The Current IP Database 214 comprises historical IP addresses that have been previously captured and normalized by the VRM 210. Such a database is useful in avoiding redundant IP address cross-referencing. In one embodiment, if a recently captured IP address already exists in the Current IP Database 214, time and effort may be avoided in not re-querying a Registrant Lookup Database 217, such as a WhoIs database. However, the Current IP Database 214 is optional and may be bypassed allowing the Registrant Lookup Database 217 to be re-queried.

If an IP address is not found in the ISP Database 212 or the Current IP Database 214, the Registrant Lookup Database 217 may be queried to obtain this information. In one embodiment, the Registrant Lookup Database 217 may include one or more external or internal databases comprising ownership or registrant information for each IP address registered on the Internet. In one embodiment, the information obtained from the Registrant Lookup Database 217 may include the name of the owner of the IP address, the physical address of the owner, the hostname associated with the IP address, technical contacts, phone numbers associated with the owner, and an IP address block. In another embodiment, the Registrant Lookup Database 217 may be queried before the ISP Database 212 and the Current IP Database 214. In another embodiment, multiple Registrant Lookup database may be queried. In yet another embodiment, data collected from one or more Registrant Lookup databases can be stored in one or more additional databases (not shown) and queried. In other words, following a visitor's IP address being captured and transmitted by a script, the Registrant Lookup Database 217 may be queried.

The ISP Filtering Module 216 comprises logic to determine how a single IP address, or a range or block of IP addresses associated with the Registrant 205 may be associated. ISP Filtering Module 216 may query the ISP Database 212, the Current IP Database 214, and other databases to determine the association between the IP address and the underlying entity or business associated to the IP address. If an IP address is found within one of the existing databases, the IP address may be flagged as such (e.g., current IP address associated with a business or associated with an ISP). On the other hand, if the IP address is not found in one of the existing databases, ISP Filtering Module 216 may allow the IP address to pass through as a bona fide business.

In one embodiment, ISP Filtering Module 216 may attempt further filtering mechanisms to determine if an IP address is associated with an ISP. Such attempts to resolve the IP address may include the use of keywords or phrases. For example, the registered name of an IP address may contain words such as “cyber” or “telephone” amongst others. Hence, if the owner name associated with an IP address contains “cyber” or “telephone,” ISP Filtering Module 216 may discard this IP address as being associated with an ISP.

It is common for an ISP or other entity to own or control blocks or ranges of IP addresses. For example, an ISP may own or control the IP addresses from 192.11.600.xxx through 192.11.699.xxx. Therefore, an IP address of 192.11.643.883 falls within this range. Hence, in one embodiment, the ISP Filtering Module 216 may already know that a certain ISP owns this range of IP addresses. Therefore, when presented with the JP address 192.11.643.883, no furthering querying may be needed to determine whether the address comes from an ISP.

Another filtering mechanism utilized by the ISP Filtering Module 216 is to look for an underlying business associated with an IP address, even when an ISP appears as the owner or controlling entity. It is common for a business lease IP addresses from an ISP such as AT&T or other types of entities. Therefore, when analyzing the domain associated with an IP address, AT&T may be returned. However, further analysis may reveal the IP address is actually leased to a business. In one embodiment, such leasing information may be obtained by researching the ownership record of the registrant of the IP address. Such information may be stored in an internal or externally maintained database. If such leasing information is obtained, the IP address becomes associated with the business and not the ISP leasing the IP address. On the other hand, if such resolution cannot be obtained, the IP address may be discarded as associated with an ISP and untraceable to a business.

The Hosting Center Database 218 is another filtering type of database. When a database such as Registrant Lookup Database 217 is queried to return information about an IP address, the physical address of the entity is often included. At times, the physical address shown is not the actual address of the entity, but rather the address of a commercial hosting center. These IP addresses have a viable owner name associated with them. However, the physical address corresponds to one or more commercial hosting centers that the underlying owner may have hired to maintain, purchase, or lease the web server equipment associated with the IP address. If an IP address is shown to have its physical address as a hosting center, the physical address fields may be changed to “Hosting Center Address,” or other such identifier that may alert a user to the suspicion of the data. One or more databases (not shown) may contain the information for making such determinations.

The Geo Coding Database 220 contains geo coding information. In one embodiment, geo coding is the extraction of the general physical location of the visitor visiting the website 205. An IP address comprises a sequence of numbers which have similar functionality to a physical address. As described above, a portion of the IP address may be used to determine who owns or controls the IP address and the associated business's address. Another portion of the IP address may be analyzed to determine the physical location of the visitor. This address is in contrast to the address associated with the business that owns or controls the IP address. For example, an IP address could show that the business owning the address is Computers, Inc. located in Boston, Mass. However, geo coding may show that the physical location of the visitor is Philadelphia, Pa. In other words, the location of the entity owning or controlling an IP address is independent of the physical location of the visitor whose computer or device has been assigned that IP address. In one embodiment, geo coding information includes city, state, zip code, and country where the visitor is currently residing. In another embodiment, longitude and latitude coordinates may be included in the geo coding information. Rarely will the location have such granularity to include a street address.

The Internal Business and Contacts Database 222 (“IBC Database”) is a collection of one or more data repositories for storing the businesses and related information associated with IP addresses extracted from the visitors navigating to websites utilizing the VT System 200. Additionally, individual contacts from each business may also be included in the data repositories. Hence, when new IP addresses are extracted and processed by the modules and databases described above, one or more records may be added to the IBC Database 222 including the IP address, the business associated with the IP address, and personnel associated with that business. In one embodiment, the personnel added to the IBC Database 222 may be based on user-defined characteristics and not just general contacts associated with the business. In other words, a user may define an interest in personnel contacts with certain keywords in their title or position, etc. Hence, contacts will be added to the IBC Database 222 that meet such criterion.

In one embodiment, the External Business and Contacts Database 232 (“EBC Database”) comprises information relating to individual persons associated with businesses. In one embodiment, when contact information is desired for an extracted IP address, VRM 210 may request such information, approximately in real-time, from the EBC Database 232. In one embodiment, once the contact information is retrieved, it may be placed in the IBC Database 222 and associated with the IP address. As previously mentioned, the contact information retrieved from the EBC Database 232 may be based on one or more user-defined criterion for the type of contact desired by the user.

In another embodiment, a Synchronization and Hygiene Module 234 may be used. When multiple databases (e.g., WhoIs Database, EBC Database, IBC Database, etc.) are being utilized, discrepancies between data standards and naming conventions may be apparent. For example, the formal name for Boeing may differ across each database. One database may refer to The Boeing Company. Other database may use The Boeing Corporation or Boeing, Inc. Other disparate naming conventions may occur in business addresses as well. In order to rectify such discrepancies, the Synchronization Module 234 may be used to provide for standardized naming across each database.

Another functional feature of the VT System 200 is the Query String Parsing Module 224 (“QSP Module”). As previously stated, there are many pieces of information sent to the VT System 200 from the embedded script from each page in the website 205. In addition to the data items already described, the query string is also provided to the VT System 200. In one embodiment, a query string contains referral information indicating how the visitor arrived at the website 205. This referral information may include the search engine the visitor used as well as the search term(s) used in the search engine. An example query string could be shown as the URL of http://www.Yahoo.com/search.$u&i//business+cellular+plans&ei=UTF−8&fr=s1v1&n=20&fl=0&x=wrt. Once parsed, this example indicates that the search came from YAHOO and the search terms used were “business cellular plans.” Each search engine may use differing criterion for generating a query string from a visitor's search. Therefore, QSP Module 224 may comprise logic for parsing query strings from differing engines such as YAHOO, GOOGLE, LYCOS, and MSN among others. In another embodiment, external databases may be used to provide the parsing logic used to parse a query string.

The reason for parsing a query string is to obtain the search terms and search engine used to provide this additional information to a website owner. Knowing how a visitor navigated to a website can be invaluable information. Website owners may spend large sums of time and money to attract visitors to their websites. Often times, the search terms used can provide insight as to the most attractive mechanism for bringing visitors to their websites. In the above example, a website owner can learn that visitors searching for “business cellular plans” from YAHOO's search engine will generate a result to the owner's website.

The Data Warehouse 230 is a database containing the detailed information from the visitors that have visited the website 205 and other websites utilizing the VT System 200. In one embodiment, a separate database may be dedicated to each website utilizing the VT System 200. In another embodiment, multiple websites may utilize the same database. For each visit by a visitor to the website 205, one or more records may exist in the Data Warehouse 230. These records include the information extracted from the modules and databases described above in regards to FIG. 2.

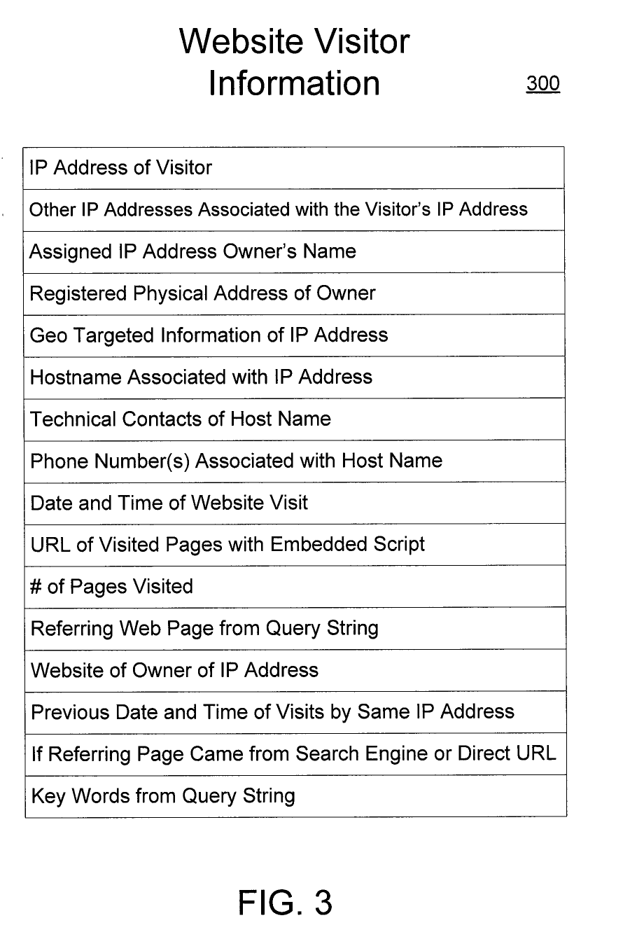

FIG. 3 is table illustrating information acquired for each visitor navigating to a website in accordance with an illustrative embodiment of the invention. Table 300 illustrates a plurality of values corresponding to a visit to the website 205, as well as the business associated with the visitor. One skilled in the art can appreciate that more or less information may be captured and stored in each database record. Further, one or more database tables may be used to store this information without deviating from the scope of the invention.

Returning to FIG. 2, the Administration Controls Module 236 (“Admin Module”) allows for configuration and maintenance of the VRM 210. In one embodiment, the Admin Module 236 may be responsible for updating the software in the other modules, deleting or moving database records that are older than a threshold age, and tuning the modules and databases to improve performance, etc. In one embodiment, maintenance may be done as scheduled intervals or through automated event triggers. In another embodiment, the interface to the Administrative Controls Module 236 may be accessible through a web-based interface, a client-side application, or other means known by those skilled in the art.

Additional functions of the Admin Module 236 configure the output of information from the VRM 210 to the clients 203. There are two modules responsible for generating information to the clients 203. These include the E-mail Module 240 and the Report Generator Module 244. The E-mail Module 240 is responsible for generating emails or instant messages to the clients 203 if one or more events or pre-defined client business rules are triggered.

In one embodiment, the Alerts Module 242 and the Targets Module 246 work together to maintain information relating to the users to be emailed when a predefined event is triggered. In an example, an event may be defined as a visitor who has viewed more than 25 web pages during his or her visit. Another event may be when the IP address of the visitor is associated with a specific business name. Once an event has been triggered, one or more email addresses associated with the event may be passed to the E-mail Module 240. E-mail Module 240 may then generate an email or instant message to the recipient, notifying him or her of the triggered event. Additionally, the email message may contain a report of the business information associated with the visitor, based on his or her IP address. Further, information regarding individual contacts within the business, which meet the user-defined criterion for desirable contacts, may also be included in the emailed report. Hence, the email recipient may know, approximately in real-time, who visited a relevant website, along with one or more contact persons associated with the visitor's business.

In another embodiment, user defined business rules may further determine which type of business contact should be included in the report. For example, User 1 may only be interested in selling his or her goods to human resources personnel. Therefore, User 1 may establish a business rule to email known contacts only if they have “Human Resources” or “HR” in their title.

In another embodiment, a business contact or the visit itself may be weighted with an importance value associated with it. In other words, a website visit may be classified with a relevance value measured in some alphanumerical scale. For example, a visit labeled as an “A Lead” or a “10 Lead” may be considered the highest likelihood as being a potential sale. Differing criterion may be used to determine the weighting to be placed on a visit. For example, a lead may be an “A Lead” if the visitor visits web pages A, B and C, the visitor's IP address correlates to IBM, and the geo coding information shows the visitor's IP address is from Colorado.

The other module responsible for generating output to the clients 203 is the Report Generator Module 244. Reports may comprise information relating to each visit from a visitor such as the pages viewed, referral information, length of visit, etc. Additionally, a report may comprise information about the business associated with each website visitor, information regarding the business, geo coding information of each visitor, and the known personnel contacts associated with each business.

In one embodiment, these reports may come in the form of spreadsheets, text documents, HTML, and XML, among others. Additionally, these reports may be emailed to the clients 203 in their entirety or as a link to the actual report. Reports created by Report Generator Module 244 may also be customized to include only the information specified by a client. For example, a report may be generated nightly and emailed to the client. In such an embodiment, the contents of the report may comprise only leads generated from the past 24 hours. Additionally, the leads may be based on website visitors that viewed at least two pages of a demo hosted on the website demo. Further, the contact data reported in these leads may be based on personnel who have “IT” in their title and whose position contains the word “director,” “vice,” or “chief”.

Reports created by the Report Generator Module 244 are not limited to static reports sent by email. The Report Generator Module may also be responsible for creating interactive reports viewable in the Client Interface 202. As previously stated, the Client Interface may be a web-based application viewable on a personal computer or mobile device or a client-based application installed locally on a personal computer or mobile device. The reports viewable from the Client Interface 202 may be interactive, providing many levels of detail. Further, reports may be custom generated without restrictions to the availability of near-real-time data. For example, reports may be generated which include website visitors still navigating the website.

As with the static reports previously described, reports displayed in the Client Interface 202 may be customized based on the numerous criterion available. One skilled in the art can appreciate that any information captured may be filtered when an interactive report is generated as described above.

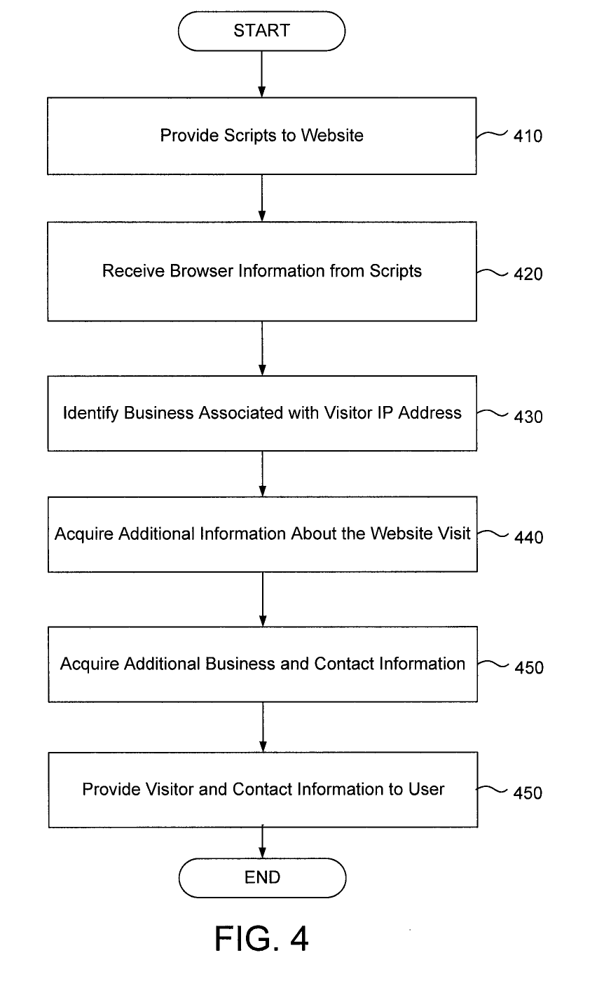

FIG. 4 is a flowchart illustrating a method for providing business contact information, relating to a website visit, to a user in accordance with an illustrative embodiment of the invention. In order to capture relevant information from a website visit, one or more scripts are placed on each web page where information from the visit is to be captured. Hence, one or more scripts are provided to a website (step 410) for inclusion on each web page. These scripts are configured to read information provided by the web browser being utilized by the visitor. In one embodiment, this information may include, without limitation, IP address, URL of the visited pages, referral information (i.e., the previous page or website the visitor visited or the search words used if the visitor came from a search engine), and optional information from cookies left on the visitor's computer used to show repeat visits to the website.

Once a visitor begins navigating a website, the browser information is received from the one or more scripts (step 420). In one embodiment, this information is transmitted from the script(s), approximately in real-time, and reported by a web-based interface. In other words, after a visitor navigates to a first web page, information begins to be transmitted. Subsequent page views induce additional transmissions from the same visit. In another example, information is locally stored about each visit until a predetermined time interval passes in which no further activity occurs (i.e., the visitor has left the website). Once the time interval is met, information regarding the visit is transmitted to a user. As the visitor information is received, it is subsequently stored in a visitor database.

Once the visitor information is received, the IP address associated with the visitor is passed to a database to retrieve information regarding the registrant or owner of the IP address, or the range of IP addresses associated with that registrant (step 430). In one embodiment, the database comprises industry standard WhoIs information capable of providing reverse lookup functionality from an IP address to its underlying registered owner. In one embodiment, the database providing WhoIs information is an internally maintained database. In another embodiment, the database is maintained by an external third party. As the IP address owner information is received, it is subsequently stored in the visitor database.

Next, additional information about the web visit and its underlying owner are generated and added into the visitor database (step 440). In one embodiment, the additionally generated information from step 440 may comprise the information obtained from the ISP Database 212, the Current IP Database 214, the ISP Filtering Module 216, the Hosting Center Database 218, the Geo Coding Database 220 and the Query String Parsing Module 224. Once the information appended from step 440 is added to the visitor database, the visit information may comprise the information as illustrated in FIG. 3.

Next, additional business and contact information are appended to the visitor database (step 450). In one embodiment, this information is obtained from an external third party database maintained by a company such as Jigsaw, Inc. located in San Mateo, Calif. In another embodiment, this information may be locally hosted and maintained with regular updates from one or more additional sources.

In one embodiment, contact information associated with one or more personnel associated with the business that owns the visitor's IP address are appended to the visitor information in the visitor database. In another embodiment, the contact information is maintained in a separate contact database. In yet another embodiment, the contact information is not locally stored but is, rather, queried each time the contact information associated with the business is requested. Each contact record may include information such as name, title, position, contact information such as address and phone number, age, and length of employment, among others. Additional supplementary information may be included in the contact record without deviating from the scope of the invention.

In one embodiment, the contact information stored in one or more databases are user-defined in scope. In other words, a user may define one or more criterion for determining the types of personnel the user wishes to receive. Hence, not all known contacts from a business may be added into a database. Rather, the contacts meeting pre-defined user criterion may be added to a database.

Lastly, the visitor and contact information is provided to a user (step 460). As previously described, this information may be presented to a user in the form of email, reports in industry standard formats, or via a user interface such as Client Interface 202. Other mediums for presenting the visitor and contact information may be utilized without deviating from the scope of the invention.

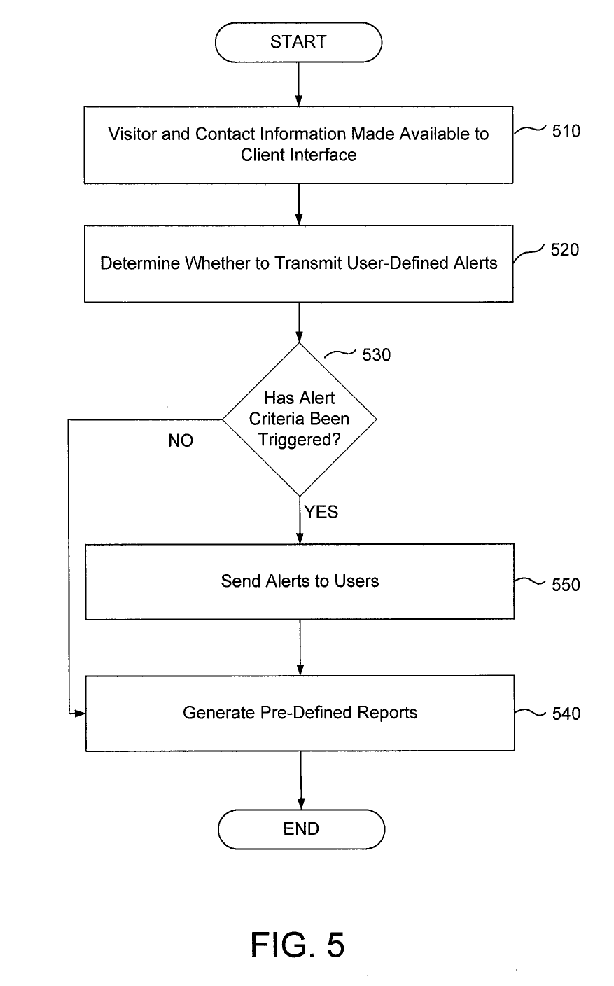

FIG. 5 is a flowchart illustrating step 460 in greater detail as a method for providing business contact information to a user in accordance with an illustrative embodiment of the invention. Once the contact information has been received and inserted into the visitor database or another database or data warehouse, the contact information is made available via the Client Interface 202 (step 510). As previously stated, this information may become available approximately in real-time. Hence, a user may access contact information, from a new visitor, from the Client Interface 202 while the visitor is still navigating the website.

After the contact information is made available in the Client Interface 202, an alerts database is queried to determine if the currently loaded visitor and contact information triggers a pre-defined client alert (step 520). Hence, a determination is made whether alerts are to be generated (step 530). If there are no alerts with criterion matching the currently loaded visitor and contact information, the method proceeds to step 540. On the other hand, if there are client alerts triggered by the currently added visitor and contact information, an alert is sent to each of the users whose alerts were triggered (step 550). In one embodiment, the alerts may be transmitted by email. The email itself may contain the relevant information requested by each alert. In another embodiment, the email may comprise an attachment or a link to a report provided in an industry standard format such a spreadsheet, HTML, etc.

In another embodiment, the criterion for an alert may further define a weighting to be placed on one or more contacts associated with a website visitor. The weighting may then be included in the alert sent to the user.

Next, in step 540, one or more reports may be generated based on pre-defined criterion for report generation and provided to a user. In one embodiment, a pre-existing report may exist where one or more new visitor and contact records may be appended to the report. In another embodiment, a report may be generated once a predetermined time interval has been reached (e.g., every 12 hours). In yet another embodiment, a report may be provided through the Client Interface 202 or as a standalone report.

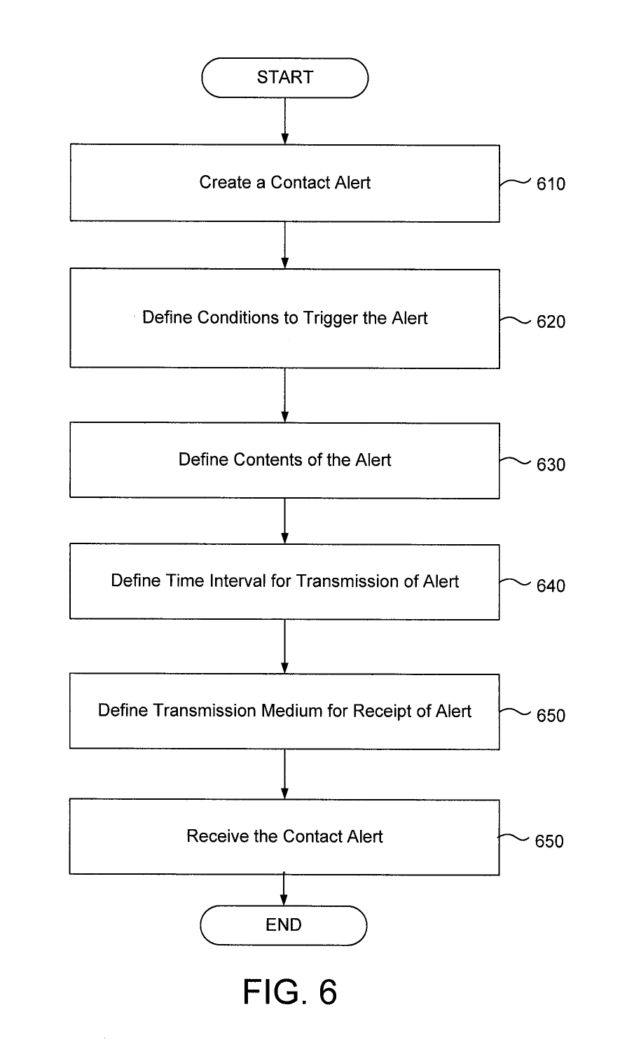

FIG. 6 is a flowchart illustrating a method for requesting and receiving a visitor and contacts report in accordance with an illustrative embodiment of the invention. First, a user creates a contact alert (step 610). In one embodiment, a contact alert is sent to the user when certain criterion, defined by the user, are met. The alert can also be customized as far as the information it contains. Once the alert has been created, the user defines the criterion for triggering the alert (step 620). The triggering criterion may consist of one or more conditions relating to incoming visitor and contact information. For example, a condition may be that the received visitor and contact information includes at least 20 pages views from the visitor. Another condition may specify the geo coding information indicate the visitor is from Colorado.

Next, the user defines the information to be included in the alert (step 630). The visitor and contact information includes a multitude of information. The user is permitted to select which fields of data they wish to see in the alert. Next, the user may determine when he or she wishes to receive the alert (step 640). In one embodiment, the user may choose to receive an alert each time a new visit is recorded. In another embodiment, the user may choose to receive an alert every six hours or after three visitors meet the user's alert criterion.

Next, the user may determine the medium means by which he or she wishes to receive the alert (step 650). Typical transmission media include email, SMS or MMS text messages, automated phone call, and a pop up window on the user's computer or mobile device or other such communication means known by those skilled in the art. Lastly, the user receives his or her alert (step 660).

In conclusion, the present invention provides, among other things, a system and method for extracting information about desired contacts associated with the business visiting a website. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims.

What is claimed is:

1. A method for providing contact information relating to website traffic statistics to a user, the method comprising:
receiving visitor information associated with a visitor to a website, wherein the visitor information includes an IP address of the visitor;
determining an entity associated with the IP address;
determining at least one person associated with the entity;
gathering contact information associated with the at least one person; and
providing the contact information to the user when the contact information meets a pre-defined criterion of the user.

2. The method of claim 1, wherein each of one or more web pages of the website includes one or more scripts that are executed when the visitor navigates to that web page, the one or more scripts being configured to read and transmit the visitor information from a web browser of the visitor.

3. The method of claim 1, wherein determining an entity associated with the IP address includes:
querying an IP address database comprising a plurality of IP addresses and a plurality of entities, wherein each of the plurality of entities is associated with at least one of the plurality of IP addresses;
receiving an entity record associated with the IP address; and
storing the entity record in a data warehouse.

4. The method of claim 3, wherein determining at least one person associated with the entity includes:
querying a contacts database comprising at least one entity and at least one person associated with the at least one entity;
receiving a record of the at least one person associated with the entity, wherein the record meets the pre-defined criterion; and
storing the record of the at least one person in the data warehouse.

5. The method of claim 4, wherein gathering contact information associated with the at least one person includes:
receiving, from a contact information database, contact information associated with the least one person wherein the contact information includes at least one of a physical address, a phone number, an email address, a title, and a position; and
storing the contact information in the data warehouse.

6. The method of claim 5, further comprising:
extracting a name of a referring website from a query string associated with a search engine, wherein the query string was included in the visitor information;
extracting at least one search term from the query string; and
storing the name of the referring website and the at least one search term in the data warehouse.

7. The method of claim 6, further comprising:
providing a user interface to the user, wherein the user interface includes the visitor information contained in the data warehouse; and
generating at least one report, accessible to the user, wherein the report comprises at least one of the IP address of the visitor, the referral website extracted from the query string, the search term extracted from the query string, the entity associated with the IP address, the at least one contact associated with the entity, and the contact information associated with the contact.

8. The method of claim 1, wherein providing the contact information to the user includes:
generating a communication containing the contact information; and
transmitting the communication to the user over a network, wherein the communication is one of an e-mail message, a text message, an instant message, an automated phone call, and a pop up window.

9. The method of claim 8, wherein generating a communication containing the contact information includes:
querying an alert database, wherein the alert database comprises an alert trigger defined by the user, the alert trigger including at least one trigger criterion for triggering transmission of the communication; and
transmitting the communication to the user, when the at least one trigger criterion has been satisfied.

10. The method of claim 1, wherein determining an entity associated with the IP address includes:
searching an information service provider (ISP) database for the IP address as a query criterion, wherein the ISP database comprises a plurality of IP addresses and an indication, for each of the plurality of IP addresses, of whether each entity associated with that IP address is an ISP;
receiving, from the ISP database, the indication for the IP address when the IP address is found in the ISP database;
determining whether an additional entity is associated with the IP address when the indication is that the entity associated with the IP address is an ISP;
modifying the entity record in the data warehouse to indicate that the IP address is associated with the additional entity when the additional entity is associated with the IP address; and
discarding the visitor information if the indication is that the IP address is associated with an ISP and no additional entities are associated with the IP address.

11. The method of claim 1, wherein the pre-defined criterion is that the contact information includes at least one of a contact position, a contact title, and a contact location.

12. A computer-readable storage medium containing a plurality of program instructions executable by a processor for providing contact information relating to website traffic statistics to a user, the plurality of program instructions comprising:
a first instruction segment configured to receive visitor information associated with a visitor to a website, wherein the visitor information includes an IP address of the visitor;
a second instruction segment configured to determine an entity associated with the IP address;
a third instruction segment configured to determine at least one person associated with the entity;
a fourth instruction segment configured to gather contact information associated with the at least one person; and
a fifth instruction segment configured to provide the contact information to the user when the contact information meets a pre-defined criterion of the user.

13. The computer-readable storage medium of claim 12, wherein each of one or more web pages on the website includes one or more scripts that are executed when the visitor navigates to that web page, the one or more scripts being configured to read and transmit the visitor information from a web browser of the visitor.

14. The computer-readable storage medium of claim 12, wherein, in determining at least one person associated with the entity, the third instruction segment is configured to cause the processor to:
query an IP address database comprising a plurality of IP addresses and a plurality of entities, wherein each of the plurality of entities is associated with at least one of the plurality of IP addresses;
receive a record of the at least one person associated with the entity, wherein the record meets the pre-defined criterion; and
store the record of the at least one person in the data warehouse.

15. The computer-readable storage medium of claim 14, wherein, in determining an entity associated with the IP address, the second instruction segment is configured to cause the processor to:
query a contacts database comprising at least one entity and at least one person associated with the at least one entity;
receive an entity record associated with the IP address; and
store the entity record in a data warehouse.

16. The computer-readable storage medium of claim 15, wherein, in gathering contact information associated with the at least one person, the fourth instruction segment is configured to cause the processor to:
receive, from a contact information database, contact information associated with the least one person wherein the contact information at least includes one of a physical address, a phone number, an email address, a title, and a position; and
store the contact information in the data warehouse.

17. The computer-readable storage medium of claim 16, further comprising:
a sixth instruction segment configured to extract a name of a referring website from a query string associated with a search engine, wherein the query string was included in the visitor information;
a seventh instruction segment configured to extract at least one search term from the query string; and
an eighth instruction segment configured to store the name of the referring website and the at least one search term in the data warehouse.

18. The computer-readable storage medium of claim 17, further comprising:
a ninth instruction segment configured to provide a user interface to the user, wherein the user interface includes the visitor information contained in the data warehouse; and
a tenth instruction segment configured to generate at least one report, accessible to the user, wherein the report comprises at least one of the IP address of the visitor, the referral website extracted from the query string, the search term extracted from the query string, the entity associated with the IP address, the at least one contact associated with the entity, and the contact information associated with the contact.

19. The computer-readable storage medium of claim 12, wherein, in providing the contact information to the user, the fifth instruction segment is configured to cause the processor to:
generate a communication containing the contact information; and
transmit the communication to the user over a network, wherein the communication is one of an e-mail message, a text message, an instant message, an automated phone call, and a pop up window.

20. The computer-readable storage medium of claim 19, wherein, in generating a communication containing the contact information, the fifth construction segment is further configured to:
query an alert database, wherein the alert database comprises an alert trigger defined by the user, the alert trigger including at least one trigger criterion for triggering transmission of the communication; and
transmit the communication to the user, when the at least one trigger criterion has been satisfied.

21. The computer-readable storage medium of claim 12, wherein, in determining an entity associated with the IP address, the second instruction segment is further configured to cause the processor to:
search an information service provider (ISP) database for the IP address as a query criterion, wherein the ISP database comprises a plurality of IP addresses and an indication, for each of the plurality of IP addresses, of whether each entity associated with that IP address is an ISP;
receive, from the ISP database, the indication for the IP address when the IP address is found in the ISP database;
determine whether an additional entity is associated with the IP address when the indication is that the entity associated with the IP address is an ISP;
modify the entity record in the data warehouse to indicate that the IP address is associated with the additional entity when the additional entity is associated with the IP address; and
discard the visitor information if the indication is that the IP address is associated with an ISP and no additional entities are associated with the IP address.

22. The computer-readable storage medium of claim 12, wherein the pre-defined criterion is that the contact information includes at least one of a contact position, a contact title, and a contact location.

23. A system for providing contact information relating to website traffic statistics to a user, the system comprising:
at least one processor; and
a memory containing a plurality of program instructions configured to cause the at least one processor to:
receive visitor information associated with a visitor to a website, wherein the visitor information includes an IP address of the visitor;
determine an entity associated with the IP address;
determine at least one person associated with the entity;
gather contact information associated with the at least one person; and
provide the contact information to the user when the contact information meets a pre-defined criterion of the user.

24. A system for providing contact information relating to website traffic statistics to a user, the system comprising:
a website traffic analysis engine;
a data warehouse for storing website visitor information, the data warehouse being coupled to the analysis engine;
a website visitor module for receiving visitor information from a website, the website visitor module being coupled to the analysis engine;
an entity resolution module for determining an entity associated with a visitor to a website, the entity resolution module being coupled to the analysis engine;
a contact resolution module for determining contact information of at least one person associated with the entity, the contact resolution module being coupled to the analysis engine;
a contact preferences module for collecting user-defined preferences of desired contact types, the contact preferences module being coupled to the analysis engine;
a communication module for communicating visitor and contact information to the user, the communication module being coupled to the analysis engine and the data warehouse;
a report generation module for generating reports comprising information from the data warehouse, the report generation module being coupled to the analysis engine, the data warehouse, and the communication module; and
a client interface for presenting reports generated by the report generation module, the client interface being coupled to the analysis engine and the data warehouse.

25. The system of claim 24 further comprising:
an information service provider (ISP) filtering module for determining whether the entity associated with the visitor is an ISP.

26. The system of claim 24 further comprising:
an ISP resolution module for determining whether an additional entity is associated with the visitor when the entity is an ISP.

27. The system of claim 24 further comprising:
a query string parsing module for extracting referral information from a query string included in the website traffic statistics.

28. The system of claim 24 further comprising:
an alert tracking module for determining when incoming website visitor statistics satisfy a criterion of a predefined alert, the alert tracking module notifying the communication module when the incoming website visitor information satisfies the criterion of the predefined alert.

29. The system of claim 24, wherein the client interface is one of a web-based application and a client-side application installable on a device of the user.
